(19) United States
(12) Patent Application Publication
(10) Pub. No.: US 2025/0266522 A1
(43) Pub. Date: Aug. 21, 2025

(54) BATTERY PACK AND BATTERY SYSTEM

(71) Applicant: Prime Planet Energy & Solutions, Inc., Tokyo (JP)

(72) Inventor: Masato NAKAYAMA, Akashi-shi (JP)

(21) Appl. No.: 19/048,969

(22) Filed: Feb. 10, 2025

(30) Foreign Application Priority Data
Feb. 20, 2024 (JP) 2024-023304

(51) Int. Cl. H01M 10/48; H01M 50/204

(52) U.S. Cl. CPC H01M 10/488; H01M 10/482; H01M 50/204

(57) ABSTRACT

A battery pack includes a plurality of cell module units and a pack case housing the plurality of cell module units. Each of the cell module units includes a cell module including a plurality of battery cells, an abnormality detection means electrically connected to the cell module to use the cell module as its power source. The abnormality detecting means is configured to output a signal to an external controller when detecting an abnormality in an entirety of the pack case.

### CROSS REFERENCE TO RELATED APPLICATIONS

The present application claims priority from Japanese Patent Application No. 2024-023304 filed on Feb. 20, 2024, which is incorporated by reference herein in its entirety.

### BACKGROUND

The present invention relates to battery packs and battery systems.

JP 2010-080135 A, for example, discloses a battery system including a plurality of battery blocks connected in series, a battery status detection circuit, and a main control circuit. Each battery block includes a plurality of battery cells connected in series. The battery status detection circuit is connected to each of the battery cells, and includes a circuit that detects the voltage and temperature of the battery cells.

The battery status detection circuit outputs the voltage and temperature of each of the battery cells to the main control circuit. The main control circuit controls the status of each of the battery cells based on the voltage and temperature of each of the battery cells.

### SUMMARY

In the battery system disclosed in JP 2010-080135 A, the battery status detection circuit is electrically connected to the battery block that is to be detected, to use the battery block as the power source. If an abnormality occurs in the battery block and power is not supplied to the battery status detection circuit, it may be possible that the electric power source for the battery status detection circuit is lost. In this case, there may be a risk that the battery status detection circuit does not start properly and is thus unable to detect the status of the battery block.

In accordance with the present disclosure, a battery pack includes a plurality of cell module units, and a pack case housing the plurality of cell module units. Each of the cell module units includes a cell module including a plurality of battery cells, an abnormality detection means electrically connected to the cell module to use the cell module as its power source. The abnormality detecting means is configured to output a signal to an external controller when detecting an abnormality in an entirety of the pack case.

In the battery pack disclosed herein, a plurality of cell modules are housed inside the pack case, and the abnormality detecting means is provided that is electrically connected to each of the cell modules. Therefore, even when an abnormality occurs in one of the plurality of cell modules and one of the plurality of abnormality detecting means loses power, it is possible to detect an abnormality in the entirety of the pack case by a remaining one of the abnormality detecting means.

### BRIEF DESCRIPTION OF THE DRAWINGS

FIG. 1 is a schematic view illustrating a battery system according to a first embodiment.

FIG. 2 is a flowchart illustrating an abnormality detection method.

FIG. 3 is a block diagram illustrating the configuration of a sub-controller.

FIG. 4 is a schematic view illustrating a battery system according to a second embodiment.

### DETAILED DESCRIPTION

Hereinbelow, embodiments of the technology according to the present disclosure will be described with reference to the drawings. It should be noted, however, that the embodiments disclosed herein are, of course, not intended to limit the invention. The drawings are schematic illustrations, and do not necessarily reflect any actual product. The features and components that exhibit the same effects are designated by the same reference symbols as appropriate, and the description thereof will not be repeated as appropriate.

### First Embodiment

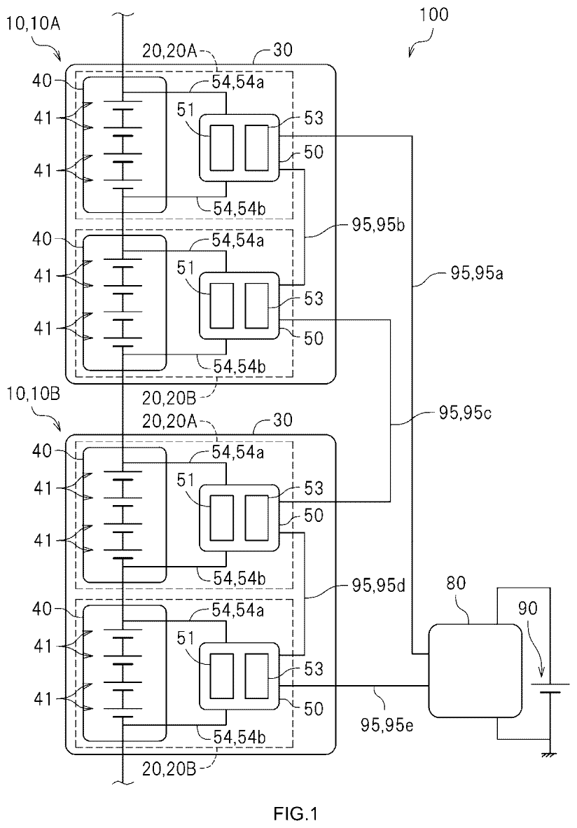

FIG. 1 is a schematic view illustrating a battery system 100 according to a first embodiment. The battery system 100 according to the present embodiment is connected to a load, not shown. The load to be connected to the battery system 100 is not limited to any particular type of load. The load may be, for example, a load in a vehicle, which may include a drive device of the vehicle, such as an electric motor, or an inverter or the like. The battery system 100 is mounted in a vehicle, such as a hybrid electric vehicle and an battery electric vehicle, and is used as the power source to supply electric power to an electric motor for driving the vehicle. The battery system 100 is, however, not limited to those for use in vehicles.

As illustrated in FIG. 1, the battery system 100 includes a plurality of battery packs 10, a controller 80, and an auxiliary equipment power supply 90. The number of battery packs 10 is not limited to any particular number, but may be two herein. The number of battery packs 10 may also be three or more. In the following description, one of the two battery packs 10 may also be referred to as a battery pack 10A and the other one may also be referred to as a battery pack 10B. Herein, the battery packs 10A and 10B have the same configuration. Hereinafter, in the description common to the battery packs 10A and 10B, the battery pack may be referred to as a battery pack 10.

The battery pack 10 includes a plurality of cell module units 20 and a pack case 30. The plurality of cell module units 20 are housed in the pack case 30. The pack case 30 is a hermetically sealed case. Herein, the phrase “hermetically sealed” means a condition in which no external air enters the inside of the pack case 30, and a condition in which the pressure inside the pack case 30 does not change due to external factors. The pack case 30 is formed of a metal, for example. However, the material that forms the pack case 30 is not limited to any particular material.

The number of the cell module units 20 housed in one pack case 30 is not limited to any particular number as long as it is plural. In the present embodiment, the number of the cell module units 20 housed in one pack case 30 is two. Herein, one of the two cell module units 20 may also be referred to as a cell module unit 20A and the other one may also be referred to as a cell module unit 20B. The cell module units 20A and 20B have the same configuration. Hereinafter, in the description common to the cell module units 20A and 20B, each cell module unit may be referred to as a cell module unit 20.

In the present embodiment, the cell module unit 20 includes a cell module 40 and an abnormality detecting means 50. The cell module 40 includes a plurality of battery cells 41. The battery cells 41 are ones that are capable of being charged and discharged. Each of the battery cells 41 may be, for example, a secondary battery in which repeated charging and discharging are possible by means of migration of charge carriers through an electrolyte between a pair of electrodes (for example, positive electrode and negative electrode). Each of the battery cells 41 may be a lithium-ion secondary battery, a nickel-metal hydride battery, or the like, for example. In the present embodiment, the plurality of battery cells 41 are connected in series. Herein, the plurality of battery cells 41 are connected in series via a bus bar, not shown. However, it is also possible that the plurality of battery cells 41 may be connected in parallel. The number of battery cells 41 in each one cell module 40 is not limited to any particular number and may be a predetermined number. The number of battery cells 41 in the cell module 40 in each of the cell module units 20 may be the same or different.

The abnormality detecting means 50 is a means that detects an abnormality in the entirety of the pack case 30. Herein, the phrase “abnormality in the entirety of pack case 30” refers to an abnormality of a component, such as a battery cell 41 of the cell module 40, that is housed in the pack case 30. The abnormality of the cell module 40 (for example, a battery cell 41) may be, for example, a high temperature abnormality that occurs due to a high temperature of the battery cell 41. The abnormality detecting means 50 is configured to output a signal to an external controller 80 when detecting an abnormality in the entirety of the pack case 30. In the following description, the phrase “abnormality in the entirety of pack case 30” may also be referred to as “abnormality inside pack case 30”. As illustrated in FIG. 1, the abnormality detecting means 50 housed in the pack case 30. However, at least some of the parts that constitute the abnormality detecting means 50 may be provided external to the pack case 30. In the present embodiment, the abnormality detecting means 50 uses the plurality of battery cells 41 contained in the cell module 40 as its power source. The abnormality detecting means 50 is electrically connected to the cell module 40 (in other words, the plurality of battery cells 41). In the present embodiment, the abnormality detecting means 50 is electrically connected to the cell module 40 via a power wire 54. The power wire 54 includes a first power wire 54a that is electrically connected to the positive electrode side of the cell module 40 and a second power wire 54b that is electrically connected to the negative electrode side of the cell module 40.

Note that the configuration of the abnormality detection element 50 is not particularly limited. Herein, as illustrated in FIG. 1, the abnormality detecting means 50 includes a pressure sensor 51 and a sub-controller 53. The pressure sensor 51 is housed in the pack case 30. In the present embodiment, each one pack case 30 houses a plurality of pressure sensors 51 (two pressure sensors 51 herein). The pressure sensor 51 detects the pressure inside the pack case 30. In the present embodiment, for example, when an abnormality occurs in the entirety of the pack case 30, the pressure inside the pack case 30 may become higher. Accordingly, the abnormality detecting means 50 detects that an abnormality is occurring in the entirety of the pack case 30 when the pressure inside the pack case 30 that is detected by the pressure sensor 51 has become higher.

The sub-controller 53 determines whether or not an abnormality is occurring in the entirety of the pack case 30, and outputs a signal to the external controller 80 if it is determined that the abnormality is occurring. The sub-controller 53 is composed of an ASIC (Application Specific Integrated Circuit), for example. However, the sub-controller 53 may be composed of a microcomputer, for example. The sub-controller 53 may include a communication interface, a central processing unit (CPU) that executes control program instructions, a read only memory (ROM) that stores programs executed by the CPU, a random access memory (RAM) used as a working area for deploying the programs, and a storage device, such as a memory, that stores the foregoing programs and various data. Note that the sub-controller 53 may be composed of a single device (for example, a single CPU) or may be configured to execute control operations by a plurality of devices in cooperation with each other.

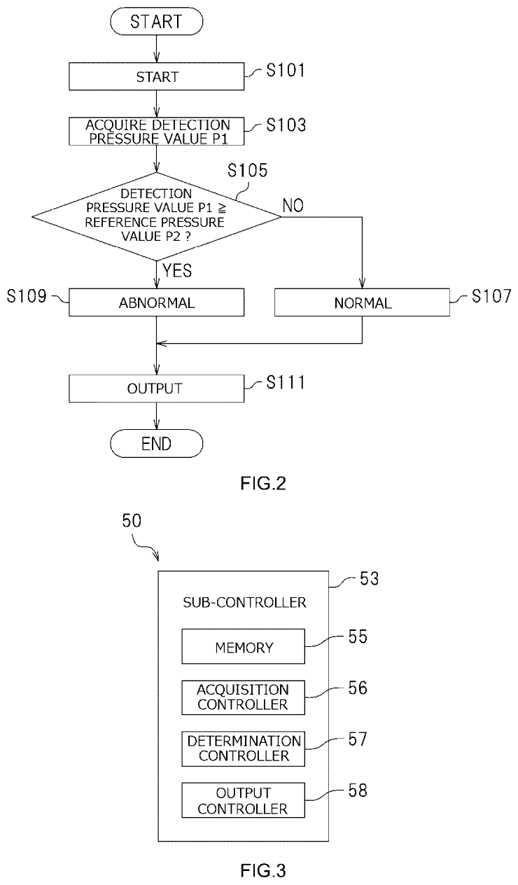

In the present embodiment, the sub-controller 53 is housed in the pack case 30. However, it is also possible that the sub-controller 53 may be provided external to the pack case 30. The sub-controller 53 is communicably connected to the pressure sensor 51 that is in the same cell module unit 20. For example, the sub-controller 53 acquires a detected pressure value P1 (see FIG. 2) inside the pack case 30, which is detected by the pressure sensor 51. Then, based on the detected pressure value P1 acquired from the pressure sensor 51, the sub-controller 53 determines whether or not an abnormality is occurring in the entirety of the pack case 30. Herein, for example, the sub-controller 53 determines whether or not the detected pressure value P1 inside the pack case 30 is higher (for example, higher than later-described reference pressure value P2 (see FIG. 2)). Then, if the sub-controller 53 determines that the detected pressure value P1 is higher (for example, higher than the reference pressure value P2), the sub-controller 53 determines that an abnormality is occurring inside the pack case 30. At this time, if the sub-controller 53 determines that an abnormality is occurring in the entirety of the pack case 30, it outputs a signal to the external controller 80. For example, the sub-controller 53 outputs an abnormality signal, which indicates that an abnormality is occurring inside the pack case 30, to the external controller 80.

In the present embodiment, as illustrated in FIG. 1, a plurality of cell module units 20 (i.e., the cell module units 20A and 20B herein) are connected in series in each one battery pack 10. The plurality of cell modules 40 included in the plurality of cell module units 20 (in other words, the plurality of battery cells 41 connected in series) are connected in series. In addition, the plurality of battery packs 10 (battery packs 10A and 10B herein) included in the battery system 100 are connected in series. In other words, the cell modules 40 included in the plurality of battery packs 10 are connected in series. However, it is also possible that the plurality of cell modules 40 may be connected in parallel.

The controller 80, like the sub-controller 53, may be composed of, for example, an ASIC, but may also be composed of a microcomputer. The controller 80, like the sub-controller 53, may include a communication interface, a central processing unit, a ROM, a RAM, a storage device, and the like. The controller 80 may be composed of a single device (for example, a single CPU) or may be configured to execute control operations by a plurality of devices in cooperation with each other. The controller 80 is provided external to the pack case 30.

In the present embodiment, the controller 80 does not use the cell modules 40 of the battery packs 10 as the power source, but uses the auxiliary equipment power supply 90 as the power source. The controller 80 is electrically connected to the auxiliary equipment power supply 90. The type of the auxiliary equipment power supply 90 may be, but is not particularly limited to, a storage battery (a lead-acid battery herein), for example.

In the present embodiment, the controller 80 is communicably connected to each of the abnormality detecting means 50 respectively included in the plurality of battery packs 10. Herein, the controller 80 is communicably connected to the plurality of sub-controllers 53 in the plurality of abnormality detecting means 50. In the present embodiment, when a sub-controller 53 detects that an abnormality is occurring in the entirety of the pack case 30, the controller 80 receives information (for example, an abnormality signal indicating that an abnormality is occurring in the entirety of the pack case 30) that is output from the sub-controller 53. By receiving the abnormality signal, the controller 80 is able to judge that an abnormality is occurring in the battery pack 10 (more specifically, inside the pack case 30) that includes the sub-controller 53 that has output the abnormality signal.

In the present embodiment, as illustrated in FIG. 1, the controller 80 and the plurality of abnormality detecting means 50 (more specifically, a plurality of sub-controllers 53) are communicably connected to each other to form a ring topology. The connection topology of the controller 80 and the plurality of sub-controllers 50 is a ring topology. In other words, the controller 80 and the plurality of abnormality detecting means 50 are connected so as to be able to communicate with each other in a loop fashion.

As illustrated in FIG. 1, for example, the controller 80 and the plurality of abnormality detecting means 50 are communicably connected via communication wires 95. Two communication wires 95 are connected to each of the controller 80 and the plurality of sub-controllers 50. The sub-controllers 53 of the plurality of abnormality detecting means 50 are able to output signals in two directions to the controller 80. In the present embodiment, the controller 80 is communicably connected to the abnormality detecting means 50 of the cell module unit 20A in the battery pack 10A via a communication wire 95a. The abnormality detecting means 50 of the cell module unit 20A in the battery pack 10A is communicably connected to the abnormality detecting means 50 of the cell module unit 20B in the battery pack 10A via a communication wire 95b. The abnormality detecting means 50 of the cell module unit 20B in the battery pack 10A is communicably connected to the abnormality detecting means 50 of the cell module unit 20A in the battery pack 10B via a communication wire 95c. The abnormality detecting means 50 of the cell module unit 20A in the battery pack 10B is communicably connected to the abnormality detecting means 50 of the cell module unit 20B in the battery pack 10B via a communication wire 95d. Then, the abnormality detecting means 50 of the cell module unit 20B in the battery pack 10B is communicably connected to the controller 80 via a communication wire 95e.

Hereinabove, an exemplary configuration of the battery system 100 according to the present embodiment has been described. Next, an abnormality detection method as to whether or not an abnormality has occurred in the entirety of the pack case 30 of one of the plurality of battery packs 10 included in the battery system 100 will be described with reference to the flowchart of FIG. 2.

FIG. 3 is a block diagram illustrating the configuration of the sub-controller 53. In the present embodiment, in order to sequentially execute the flowchart shown in FIG. 2, the sub-controller 53 of each of the abnormality detection means 50 includes a memory 55, an acquisition controller 56, a determination controller 57, and an output controller 58. Each unit of the sub-controller 53 may be implemented by a single processor or a plurality of processors, or may be implemented by a circuit.

In the present embodiment, at step S101 of FIG. 2, the battery system 100 is started. Herein, the controller 80 executes a predetermined start-up process. This start-up process causes the pressure sensor 51 and the sub-controller 53 of each of the abnormality detection means 50 to start. Herein, the start-up process by the controller 80 causes electric power to be supplied the pressure sensor 51 and the sub-controller 53 of each of the abnormality detecting means 50 from the respective cell module 40 (a plurality of battery cells 41 herein) that is electrically connected thereto via the power wire 54, to thereby start the pressure sensor 51 and the sub-controller 53 of each of the abnormality detecting means 50. Herein, the starting of the pressure sensor 51 means a state in which it can detect the detected pressure value Pl (see FIG. 2) inside the pack case 30. The starting of the sub-controller 53 means a state in which it can acquire the detected pressure value P1 detected by the pressure sensor 51 to output the detected pressure value P1 to the controller 80.

In the present embodiment, after having been started up, the pressure sensor 51 detects (i.e., measures) a detection pressure value P1 in the pack case 30 each time a predetermined sampling time elapses. However, it is also possible, for example, that the pressure sensor 51 may be configured to detect the detection pressure value P1 inside the pack case 30 at a time when it receives the detection signal transmitted from the sub-controller 53.

Next, at step S103 shown in FIG. 2, the acquisition controller 56 of the sub-controller 53 shown in FIG. 3 acquires the detection pressure value P1. In the present embodiment, when receiving a command from the controller 80, the sub-controller 53 executes an abnormality detection method. Herein, the controller 80 transmits a detection signal to each of the sub-controllers 53 (more specifically, to the sub-controllers 53 of the respective abnormality detecting means 50 of the cell module units 20A and 20B in the respective battery packs 10A and 10B) each time a predetermined detection time elapses. The sub-controller 53 that has received the detection signal starts abnormality detection. At this time, the acquisition controller 56 of the sub-controller 53 acquires the detection pressure value P1 from the pressure sensor 51. The detection pressure value P1 acquired by the acquisition controller 56 is stored in the memory 55 shown in FIG. 3.

Next, at step S105 of FIG. 2, the determination controller 57 of the sub-controller 53 shown in FIG. 3 determines whether or not an abnormality is occurring inside the pack case 30. Herein, the determination controller 57 determines whether or not the detection pressure value P1 is higher than or equal to a predetermined reference pressure value P2. For example, when an abnormality occurs in one of the plurality of cell modules 40 housed in a pack case 30, the pressure inside the pack case 30 increases. When an abnormality occurs inside the pack case 30, for example, the detection pressure value P1 detected by the pressure sensor 51 becomes higher. Therefore, the determination controller 57 determines whether or not the detection pressure value PI is higher than or equal to the reference pressure value P2 at step S105. The reference pressure value P2 is stored in advance in the memory 55 (see FIG. 3) of each of the sub-controllers 53. The reference pressure value P2 is set based on the pressure value inside a pack case 30 that is expected when an abnormality occurs in the pack case 30.

At step S105, if the determination controller 57 determines that the detection pressure value P1 is lower than the reference pressure value P2, the process next proceeds to step S107 shown in FIG. 2. At step S107, the sub-controller 53 determines that the inside of the pack case 30 is normal. On the other hand, if the determination controller 57 determines that the detection pressure value P1 is higher than or equal to the reference pressure value P2 at step S105, the process next proceeds to step S109 shown in FIG. 2. At step S109, the sub-controller 53 determines that an abnormality is occurring inside the pack case 30.

In the present embodiment, both when it is determined that the inside of the pack case 30 is normal at step S107 and when it is determined that an abnormality is occurring inside the pack case 30 at step S109, the process proceeds to step S111 shown in FIG. 2.

At step S111, the output controller 58 of the sub-controller 53 shown in FIG. 3 outputs the status inside the pack case 30 (pack status information herein) to the controller 80. Herein, the status inside the pack case 30 is either of normal status or abnormal status. According to the status inside the pack case 30, the output controller 58 outputs pack status information to the controller 80.

At step S107 of FIG. 2, for example, if the sub-controller 53 determines that the inside of the pack case 30 is normal, the output controller 58 outputs (e.g., transmits), to the controller 80, normal information, which indicates that the inside of the pack case 30 is normal, as the pack status information at step S111. Herein, the output controller 58 transmits a normal signal to the controller 80 as the normal information. On the other hand, at step S109 of FIG. 2, for example, if the sub-controller 53 determines that an abnormality is occurring inside the pack case 30, the output controller 58 outputs, to the controller 80, abnormal information, which indicates that an abnormality is occurring inside the pack case 30, as the pack status information at step S111. Herein, the output controller 58 transmits an abnormal signal to the controller 80 as the abnormal information.

In the above-described manner, the processes shown in the flowchart of FIG. 2 are executed in sequence to perform the abnormality detection method. In the present embodiment, the controller 80 transmits a detection signal to each of the sub-controllers 53 each time the predetermined detection time elapses. Each of the sub-controllers 53 executes step S103 through step S111 shown in FIG. 2 sequentially at a time when it receives the detection signal.

Note that the controller 80 performs control operations based on the pack status information that is output from each of the sub-controllers 53. As illustrated in FIG. 1, in the present embodiment, a plurality of (two herein) abnormality detecting means 50 are provided for each one pack case 30. Therefore, when the pack status information that is output from either one of the sub-controllers 53 of the two abnormality detecting means 50 is abnormal information, the controller 80 judges that an abnormality is occurring in that pack case 30 and thus an abnormality is occurring in the battery system 100. If the controller 80 determines that an abnormality is occurring in the battery system 100, the controller 80 executes a predetermined abnormality process. This abnormality process may be, but is not particularly limited to, a process of stopping the battery system 100, for example, or may be a process of sending a notification to a higher-level controller (for example, an overall controller of the vehicle in which the battery system 100 is incorporated). It should be noted that if all of the pack status information that is output from all the sub-controllers 53 is normal information, it means that the battery system 100 is normal, so the controller 80 does not perform any special control operation.

In the present embodiment, an abnormality in the entirety of the pack case 30 is detected by a plurality of abnormality detecting means 50 for each one battery pack 10, as described above. In other words, an abnormality in the entirety of one pack case 30 is detected by a plurality of abnormality detecting means 50 that are housed in that one pack case 30. A possible cause of an abnormality that occurs in the entirety of a pack case 30 may be, for example, an abnormality of one of the plurality of cell modules 40 housed in the pack case 30 (for example, a high temperature abnormality that occurs because the cell module 40 (at least one of the plurality of battery cells 41) reaches a high temperature).

Here, it is assumed that an abnormality has occurred in the cell module 40 of the cell module unit 20B of the cell module units 20A and 20B in the battery pack 10A as illustrated in FIG. 1. In this case, the inside of the pack case 30 of the battery pack 10A reaches a high temperature, and both of the abnormality detecting means 50 in the cell module units 20A and 20B detect the abnormality inside the pack case 30.

For example, if an abnormality has occurred in the cell module 40 of the cell module unit 20B, it is possible that power may not be supplied to the abnormality detecting means 50 of the cell module unit 20B, to which power is supplied from the cell module 40 in which the abnormality has occurred. When power is not supplied thereto, the abnormality detecting means 50 is unable to start properly and therefore unable to detect an abnormality inside the pack case 30. However, according to the present embodiment, both of the abnormality detecting means 50 in the cell module units 20A and 20B detect an abnormality inside the pack case 30. Therefore, even if the abnormality detecting means 50 of the cell module unit 20B loses power and is unable to operate, the abnormality detecting means 50 of the cell module unit 20A is able to operate to detect an abnormality inside the pack case 30.

In the present embodiment, as illustrated in FIG. 1, the connection topology of the controller 80 and the plurality of abnormality detecting means 50 (more specifically, the sub-controllers 53) is a ring topology. The pack status information is output from the sub-controllers 53 to the controller 80 through the communication wires 95. If an abnormality occurs in the cell module 40 of the cell module unit 20B of the battery pack 10A and thus the abnormality detecting means 50 in the cell module unit 20B of the battery pack 10A is unusable as described above, the communication wires 95b and 95c that are connected to that abnormality detecting means 50 are accordingly unusable. For this reason, in this case, the output controller 58 of the sub-controller 53 in the cell module unit 20A of the battery pack 10A, for example, outputs the pack status information to the controller 80 through the communication wire 95a. The output controller 58 of the sub-controller 53 in the cell module unit 20A of the battery pack 10B, for example, outputs the pack status information to the controller 80 through the communication wires 95d and 95e.

As described above, in the present embodiment, the battery system 100 includes a battery pack 10 and a controller 80, as illustrated in FIG. 1. The battery pack 10 includes a plurality of cell module units 20 and a pack case 30 housing the plurality of cell module units 20. Each of the cell module units 20 includes a cell module 40 including a plurality of battery cells 41, an abnormality detection means 50 electrically connected to the cell module 40 to use the cell module 40 as its power source. The abnormality detecting means 50 is configured to output a signal to an external controller 80 when detecting an abnormality in the entirety of the pack case 30. The controller 80 is communicably connected to the plurality of the abnormality detecting means 50 in the battery pack 10 and is provided external to the pack case 30. This means that a plurality of cell modules 40 are housed inside one pack case 30, and the abnormality detecting means 50 electrically connected to the respective cell modules 40 are provided inside the one pack case 30. Therefore, even when an abnormality occurs in one of the plurality of cell modules 40 and one of the plurality of abnormality detecting means 50 loses power, it is possible to detect an abnormality in the entirety of the pack case 30 by a remaining one of the abnormality detecting means 50.

For example, in FIG. 1, the pack case 30 of the battery pack 10A houses the cell modules 40 of the cell module units 20A and 20B. Therefore, an abnormality in the entirety of the pack case 30 is detected by the two abnormality detecting means 50. For example, even when an abnormality occurs in the cell module 40 of the cell module unit 20B and the abnormality detecting means 50 of the cell module unit 20B loses power, it is possible to detect an abnormality in the entirety of the pack case 30 by the abnormality detecting means 50 of the cell module unit 20A. Thus, it is possible to detect an abnormality in the entirety of the pack case 30 appropriately.

In the present embodiment, the pack case 30 is hermetically sealed. The abnormality detecting means 50 includes a pressure sensor 51 that detects a detection pressure value P1 (see FIG. 2) inside the pack case 30. Herein, because the pack case 30 is hermetically sealed, the pressure inside the pack case 30 may become higher when an abnormality occurs inside the pack case 30. Accordingly, by detecting the detection pressure value Pl inside the pack case 30 with the pressure sensor 51, the abnormality detecting means 50 is able to detect an abnormality inside the pack case 30 based on the detection pressure value P1.

In the present embodiment, the abnormality detecting means 50 includes a sub-controller 53. The sub-controller 53 includes an acquisition controller 56 (see FIG. 3) that acquires a detection pressure value P1 from the pressure sensor 51, and a determination controller 57 (see FIG. 3) that determines whether or not the detection pressure value P1 acquired by the acquisition controller 56 is higher than or equal to a predetermined reference pressure value P2 (see FIG. 2). The sub-controller 53 is configured to detect that, if the determination controller 57 determines that the detection pressure value P1 is higher than or equal to the reference pressure value P2, an abnormality is occurring in the entirety of the pack case 30. Herein, the reference pressure value P2 may be the minimum pressure value inside the pack case 30 that is expected when an abnormality occurs inside the pack case 30. This makes it possible to detect an abnormality inside the pack case 30 by a simple control operation of determining whether or not the detection pressure value P1 is higher than or equal to the reference pressure value P2.

In the present embodiment, as illustrated in FIG. 1, the battery system 100 includes a plurality of battery packs 10. The connection topology of the controller 80 and the plurality of abnormality detecting means 50 in the plurality of battery packs 10 is a ring topology. Thus, by employing a ring topology for connecting the plurality of abnormality detecting means 50 and the controller 80 in this way, additional battery packs 10 may be connected more easily even when the number of the battery packs 10 needs to be increased, resulting in higher scalability. For example, in the example of FIG. 1, when one additional battery pack 10 needs to be provided, the one additional battery pack 10 may be disposed between the abnormality detecting means 50 of the cell module unit 20B of the battery pack 10B and the communication wire 95e.

Moreover, in the present embodiment, by employing a ring topology for the above-mentioned connection topology, the abnormality detecting means 50 is able to output a signal to the controller 80 in two directions. For example, the abnormality detecting means 50 of the cell module unit 20A of the battery pack 10A is able to output a signal from two directions, the communication wire 95a end and the communication wire 95b end, to the controller 80. Therefore, even if the abnormality detecting means 50 of the cell module unit 20B of the battery pack 10A loses power, the abnormality detecting means 50 of the cell module unit 20A of the battery pack 10A is able to output a signal to the controller 80 through the communication wire 95a.

### Second Embodiment

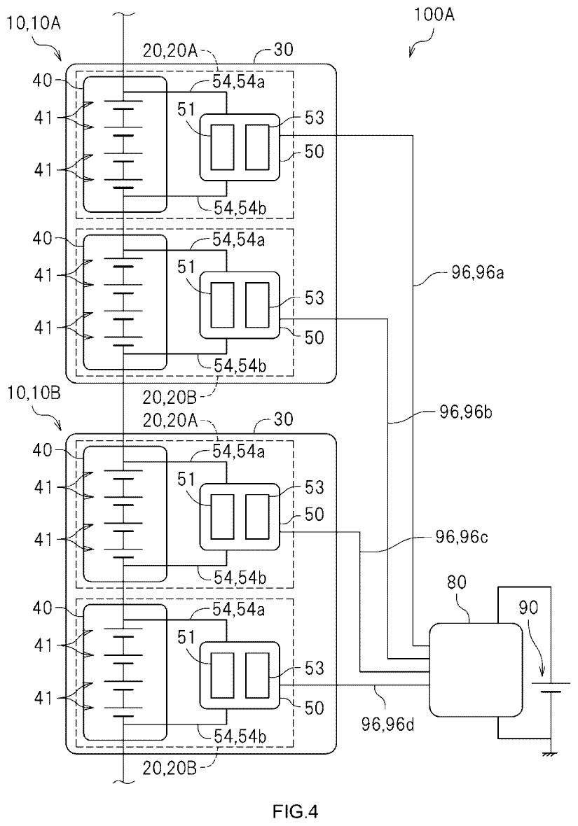

Next, a battery system 100A according to a second embodiment will be described. FIG. 4 is a schematic view illustrating the battery system 100A according to the second embodiment. As illustrated in FIG. 4, in the present embodiment, the battery system 100A includes a plurality of battery packs 10 (battery packs 10A and 10B herein), a controller 80, and an auxiliary equipment power supply 90. Except for the connection topology of the respective abnormality detecting means 50 in the plurality of battery packs 10 and the controller 80, the configuration of the battery system 100A is identical to that of the battery system 100 according to the first embodiment, and therefore, the description of the configuration of the battery system 100A will be omitted as appropriate.

In the present embodiment, the connection topology of the controller 80 and the plurality of abnormality detecting means 50 (more specifically, the sub-controllers 53) in the plurality of battery packs 10 (the battery packs 10A and 10B herein) is a star topology. That is, the plurality of abnormality detecting means 50 are communicably connected to the controller 80 independently.

As illustrated in FIG. 4, the sub-controllers 53 of the plurality of abnormality detecting means 50 are communicably connected to the controller 80 via communication wires 96. Herein, the sub-controller 53 of the cell module unit 20A of the battery pack 10A is communicably connected to the controller 80 via a communication wire 96a, and the sub-controller 53 of the cell module unit 20B of the battery pack 10A is communicably connected to the controller 80 via a communication wire 96b. Likewise, the sub-controller 53 of the cell module unit 20A of the battery pack 10B is communicably connected to the controller 80 via a communication wire 96c, and the sub-controller 53 of the cell module unit 20B of the battery pack 10B is communicably connected to the controller 80 via a communication wire 96d. Note that although one communication wire 96 connects the sub-controller 53 of each one abnormality detecting means 50 and the controller 80 to each other in the present embodiment, it is also possible to use a plurality of communication wires 96 to connect them.

Thus, when the connection topology of the respective abnormality detecting means 50 in the plurality of battery packs 10 and the controller 80 is a star topology as well, the abnormality detecting means 50 are likewise able to output signals to the controller 80 even if the electric power source for another abnormality detecting means 50 is lost. Therefore, it is possible to obtain the same advantageous effects as those obtained by the first embodiment.

In each of the above-described embodiments, the abnormality detecting means 50 includes a pressure sensor 51 and detects the detection pressure value P1 inside the pack case 30 with the pressure sensor 51. Then, based on the detection pressure value P1, the abnormality detecting means 50 detects an abnormality inside the pack case 30 when the detection pressure value P1 is higher than or equal to the reference pressure value P2. However, the abnormality detecting means 50 may detect an abnormality inside the pack case 30 based on a value other than the pressure inside the pack case 30.

For example, the abnormality detecting means 50 may also include a gas sensor that detects a detected gas concentration of a predetermined type of gas inside the pack case 30. In this case, the sub-controller 53 of the abnormality detecting means 50 may acquire the detected gas concentration in the pack case 30 that has been detected by the gas sensor and detect an abnormality in the entirety of the pack case 30 when the detected gas concentration is higher than or equal to a predetermined reference concentration.

The abnormality detecting means 50 may also include a thermal fuse that is housed in the pack case 30 and that blows out when the temperature inside the pack case 30 increases (for example, when the temperature reaches higher than or equal to a predetermined reference temperature). In this case, the abnormality detecting means 50 may detect an abnormality in the entirety of the pack case 30 by blowing out of the thermal fuse. In addition, the abnormality detecting means 50 may also include a temperature sensor that detects a detection temperature inside the pack case 30. In this case, the sub-controller 53 of the abnormality detecting means 50 may detect an abnormality in the entirety of the pack case 30 when the detected temperature inside the pack case 30 that is detected by the temperature sensor is higher than or equal to a predetermined reference temperature.

Various embodiments of the invention have been described hereinabove according to the present disclosure. Unless specifically stated otherwise, the embodiments described herein do not limit the scope of the present invention. It should be noted that various other modifications and alterations may be possible in the embodiments of the invention disclosed herein. In addition, the features, structures, or steps described herein may be omitted as appropriate, or may be combined in any suitable combinations, unless specifically stated otherwise.

As has been described above, the present description contains the disclosure as set forth in the following items.

Item 1:

A battery pack including:

a plurality of cell module units; and

a pack case housing the plurality of cell module units, wherein:

each of the cell module units includes:
a cell module including a plurality of battery cells; and
an abnormality detecting means electrically connected to the cell module to use the cell module as its power source; and

the abnormality detecting means is configured to output a signal to an external controller when detecting an abnormality in an entirety of the pack case.

Item 2:

The battery pack according to item 1, wherein:

the pack case is hermetically sealed; and

the abnormality detecting means includes a pressure sensor detecting a detection pressure value inside the pack case.

Item 3:

The battery pack according to item 2, wherein:

the abnormality detecting means includes a sub-controller;

the sub-controller includes:
an acquisition controller acquiring the detection pressure value from the pressure sensor; and
a determination controller determining whether or not the detection pressure value acquired by the acquisition controller is higher than or equal to a predetermined reference pressure value; and

the sub-controller is configured to detect that, if the determination controller determines that the detection pressure value is higher than or equal to the reference pressure value, an abnormality is occurring in an entirety of the pack case.

Item 4:

A battery system including:

at least one battery pack according to any one of items 1 through 3; and

a controller, communicably connected to a plurality of the abnormality detecting means in the at least one battery pack and disposed external to the pack case.

Item 5:

The battery system according to item 4, wherein:

the at least one battery pack includes a plurality of battery packs; and

the plurality of abnormality detecting means in the plurality of battery packs and the controller are connected in a ring topology.

Item 6:

The battery system according to item 4, wherein:

the at least one battery pack includes a plurality of battery packs; and

the plurality of abnormality detecting means in the plurality of battery packs and the controller are connected in a star topology.

What is claimed is:

1. A battery pack comprising:
a plurality of cell module units; and
a pack case housing the plurality of cell module units, wherein:
each of the cell module units includes:
a cell module including a plurality of battery cells; and
an abnormality detecting means electrically connected to the cell module to use the cell module as its power source; and
the abnormality detecting means is configured to output a signal to an external controller when detecting an abnormality in an entirety of the pack case.

2. The battery pack according to claim 1, wherein:
the pack case is hermetically sealed; and
the abnormality detecting means includes a pressure sensor detecting a detection pressure value inside the pack case.

3. The battery pack according to claim 2, wherein:
the abnormality detecting means includes a sub-controller;
the sub-controller includes:
an acquisition controller acquiring the detection pressure value from the pressure sensor; and
a determination controller determining whether or not the detection pressure value acquired by the acquisition controller is higher than or equal to a predetermined reference pressure value; and
the sub-controller is configured to detect that, if the determination controller determines that the detection pressure value is higher than or equal to the reference pressure value, an abnormality is occurring in an entirety of the pack case.

4. A battery system comprising:
at least one battery pack according to claim 1; and
a controller, communicably connected to a plurality of the abnormality detecting means in the at least one battery pack and disposed external to the pack case.

5. The battery system according to claim 4, wherein:
the at least one battery pack includes a plurality of battery packs; and
the plurality of abnormality detecting means in the plurality of battery packs and the controller are connected in a ring topology.

6. The battery system according to claim 4, wherein:
the at least one battery pack includes a plurality of battery packs; and
the plurality of abnormality detecting means in the plurality of battery packs and the controller are connected in a star topology.
